(19) United States
(12) Patent Application Publication
(10) Pub. No.: US 2016/0087376 A1
(43) Pub. Date: Mar. 24, 2016

(54) SIGNALING LINK GROUNDING

(71) Applicant: INTEL CORPORATION, SANTA CLARA, CA (US)

(72) Inventors: CHUNG-HAO CHEN, Portland, OR (US); YUN LING, Portland, OR (US); XIANG LI, Portland, OR (US)

(73) Assignee: INTEL CORPORATION, SANTA CLARA, CA (US)

(21) Appl. No.: 14/492,967

(22) Filed: Sep. 22, 2014

(51) Int. Cl. H01R 13/652; H01R 13/6597

(52) U.S. Cl. CPC H01R 13/652; H01R 13/6597

(57) ABSTRACT

Techniques for signal grounding are described herein. The techniques include a conductive element conductively coupled to an exposed ground pad of a circuit board. The conductive element is to conductively couple to a shield of a signaling link, and thereby conductively coupling the shield to the exposed ground pad.

### TECHNICAL FIELD

This disclosure relates generally to techniques signal link grounding. More specifically, this disclosure relates to a conductive element to couple to a shield of a signaling link.

### BACKGROUND

In some computing devices, a transmitted signal may be received at a receiver via a signaling link. Some signaling links include exposed signaling lanes. These types of signaling links may be used to reduce cost. For example, in a Flexible Flat Cable (FFC) signaling wires may be left uncovered on at least one side of the FFC. However, because of the bare wire connection without a ground shielding, FFC cables show poor impedance matching, high insertion loss, and high noise radiation causing radio frequency interference (RFI). In some circumstances, unshielded cables may not be used for transmitting high speed signals because of the poor characteristics. In some cases, a shield may be provided to cover the wires of an FFC, yet typically the shield is not grounded, except for by adding an additional grounding wire.

### BRIEF DESCRIPTION OF THE DRAWINGS

FIG. 1 is a block diagram illustrating a side view of a system for grounding a signaling link;

FIG. 2 is a block diagram illustrating a top view of the system for grounding a signaling link;

FIG. 3 is a block diagram illustrating a top view of the system for grounding a signaling link;

FIG. 4 is a top view of an electromagnetic gasket for coupling the shield to the ground plane; and

FIG. 5 is a block diagram illustrating a method for grounding a signaling link.

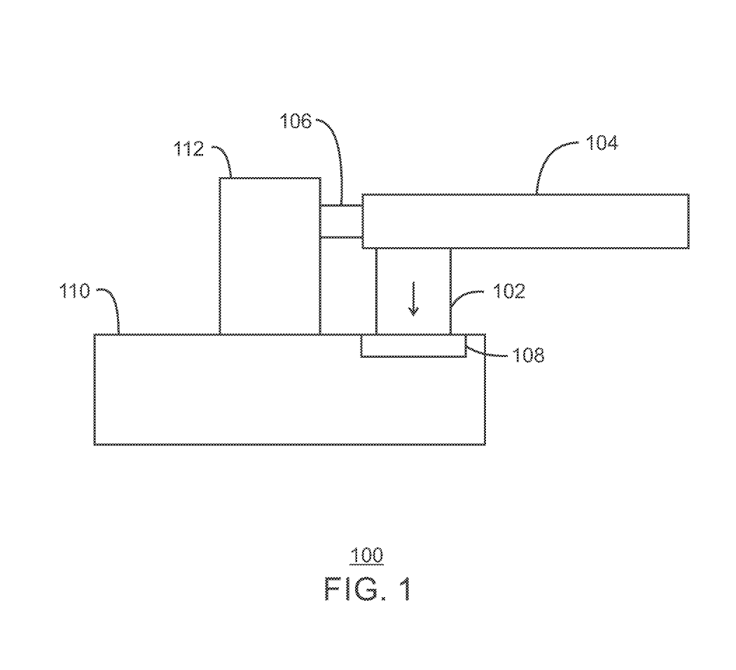

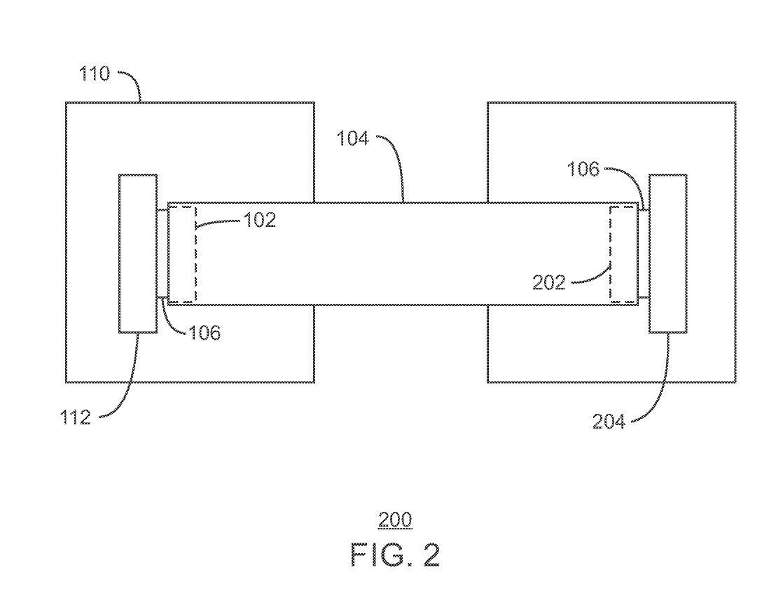

In some cases, the same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In the aspects discussed below, techniques for grounding a signaling link are described herein. As discussed above, some signaling links comprise cables having shields that are not grounded, unless an additional grounding wire configured to be received at a connector of a printed circuit board (PCB). The techniques provided herein include a conductive element to be conductively coupled to an exposed ground pad of a circuit board, such as a PCB. The conductive element is further configured to conductively couple a shield of a signaling link to the exposed ground pad.

The signaling link may be a Flexible Flat Cable (FFC) in some cases. However, other types of signaling links having shields to conductively couple to the ground plane via the conductive element may be implemented.

FIG. 1 is a block diagram illustrating a side view of a system for grounding a signaling link. The system for grounding includes a conductive element 102 conductively coupling a shield 104 of a signaling link 106 to a ground pad 108 of a printed circuit board 110.

The signaling link 106 may be an FFC and the connector 112 may be a connector configured to receive FFC signaling. In some cases, the conductive element 102 may be an electromagnetic interference (EMI) gasket. As discussed in more detail below, an EMI gasket may be a compressible component. In other words, the EMI gasket may be resilient, and as signaling link 106 is connected to the connector 112, a downward force may increase pressure, and conductive coupling between the conductive element 102 and the shield 104, as indicated by the arrow in FIG. 1. In some cases, the EMI gasket may be adhered to the grounding pad 108 via conductive adhesive.

In some cases, the conductive element 102 itself may be a conductive adhesive such as solder. In this scenario, the shield 104 may be soldered directly to the grounding pad 108.

In either scenario, the conductive element 102 removes the need for an additional grounding pin to be added to the signaling link 106 as well as the connector 112. As illustrated in FIG. 1, the conductive element 102 may be adjacent to a connector 112. This may enhance a grounding mechanism by being close to signaling pins of the connector 112.

FIG. 2 is a block diagram illustrating a top view of the system for grounding a signaling link. The top view 200 of the system for grounding the signaling link 106. As illustrated in FIG. 2, the system may include the conductive element 102 on one end of the signaling link 106, as well as a conductive element 202 on another end of the signaling link 106. Rather than requiring all connectors, such as the connector 112 and the connector 204 to include grounding pins, the techniques described herein enable grounding of the shield 104 via the conductive element 102 and/or 202.

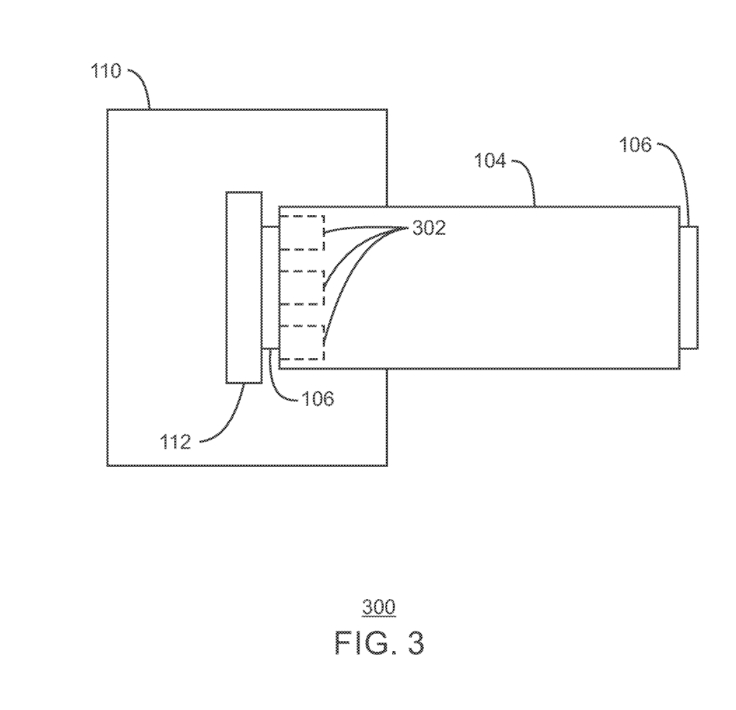

FIG. 3 is a block diagram illustrating a top view of the system for grounding a signaling link. In some cases, a cost of a conductive element may be less when smaller sized elements are acquired. As illustrated in FIG. 3, pluralities of conductive elements 302 are used to conductively couple the shield 104 to a grounding plane, such as the grounding plane 108 of FIG. 1.

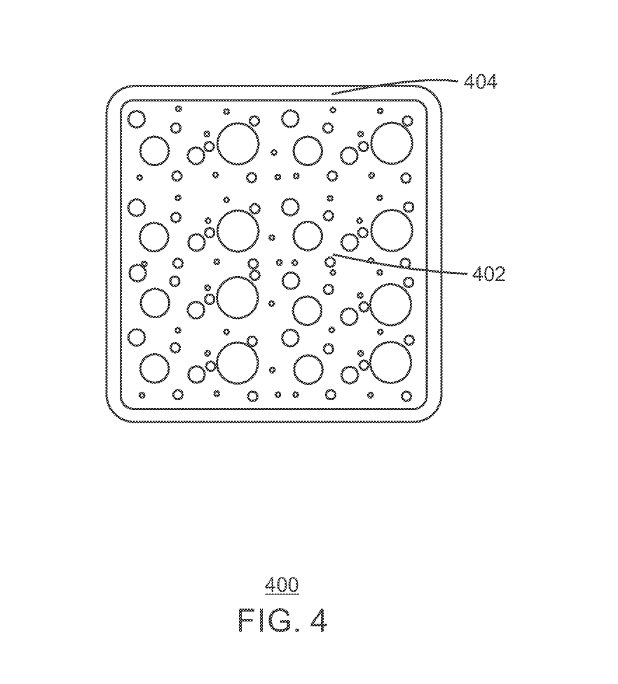

FIG. 4 is a top view of an electromagnetic gasket for coupling the shield to the ground plane. As discussed above, the conductive element may be an EMI gasket 400. The EMI gasket 400 includes a polyurethane center 402 wrapped in a conductive fabric 404. The conductive fabric 404 may enable the conductive coupling between the shield 104 of the signaling link 106 and the ground pad 108 of the circuit board 110.

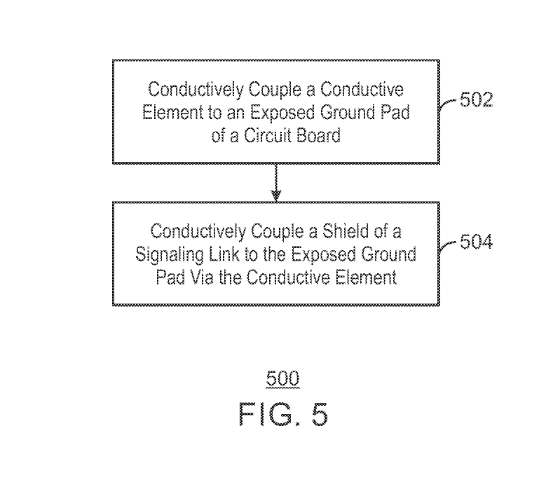

FIG. 5 is a block diagram illustrating a method for grounding a signaling link. The method 500 includes conductively coupling a conductive element to an exposed ground pad of a circuit board at block 502. At block 504, the method 500 includes conductively coupling a shield of a signaling link to the exposed ground pad via the conductive element.

The method 500 may include compressing the conductive element by way of conductively coupling the shield to the exposed ground pad. As discussed above in regard to FIG. 1, the conductive element may be a compressible EMI gasket, and may be compressed when the signaling link is received into a connector associated with the signaling link. The reception of the signaling link into the connector may conductively couple the EMI gasket to both the shield and the grounding pad.

Further, the method 500 may include generating a reduction of radio frequency interference (RFI) associated with the signaling link. In some cases, RFI generated from a signaling link, such as an FFC may interfere with operations of other components such as a Wireless Fidelity (Wifi) antenna. The reduction in RFI may be generated by the coupling of the shield to the exposed ground pad.

In some cases, the method 500 includes generating an increase in impedance matching between the signaling link and a computing system associated with the signaling link via the coupling of the shield to the exposed ground pad. As the shield is grounded, impedance properties of the signaling link are more predictable, and therefore, more configurable to match a target impedance of a computing system, or at least a component to which the signaling link is connected.

Further, in some cases, the method 500 includes forming the exposed ground pad adjacent to a connector operable to receive the signaling link. In yet other aspects, the signaling link does not include grounding pins. This may reduce the total pin count, and as a result, a cheaper cable and connector may be implemented. Further, a smaller footprint requirement of the connector may be implemented during PCB layout.

Example 1 includes an apparatus for signal grounding. The apparatus may include a conductive element, wherein the conductive element is conductively coupled to an exposed ground pad of a circuit board. In some cases, the circuit board may be a printed circuit board having an exposed ground pad.

Example 2 incorporates the subject matter of Example 1. In this example, the signaling link is a flexible flat cable (FFC).

Example 3 incorporates the subject matter of any combination of Examples 1-2. In this example, the conductive element comprises a compressible electromagnetic interference gasket.

Example 4 incorporates the subject matter of any combination of Examples 1-3. In this example, the conductively coupling between the shield and conductive element is increased by the compressibility of the conductive element.

Example 5 incorporates the subject matter of any combination of Examples 1-4. In this example, the conductive element is one of a plurality of conductive elements to conductively couple the shield to the exposed ground.

Example 6 incorporates the subject matter of any combination of Examples 1-5. In this example, the conductive element comprises a conductive adhesive to conductively couple the shield to the exposed ground pad.

Example 7 incorporates the subject matter of any combination of Examples 1-6. In this example, the communicative coupling between the shield and the exposed ground pad generates a reduction in radio frequency interference associated with the signaling link.

Example 8 incorporates the subject matter of any combination of Examples 1-7. In this example, the communicative coupling between the shield and the exposed ground pad generates an increase in impedance matching between the signaling link and a computing system associated with the signaling link.

Example 9 incorporates the subject matter of any combination of Examples 1-8. In this example, the exposed ground pad is adjacent to a connector operable to receive the signaling link.

Example 10 incorporates the subject matter of any combination of Examples 1-9. In this example, the signaling link does not include grounding pins.

Example 11 includes a method for signal grounding. The method includes conductively coupling a conductive element to an exposed ground pad of a circuit board. The method also includes conductively coupling a shield of a signaling link to the exposed ground pad via the conductive element.

Example 12 incorporates the subject matter of Example 11. In this example, the signaling link is a flexible flat cable (FFC).

Example 13 incorporates the subject matter of any combination of Examples 11-12. In this example, the conductive element comprises a compressible electromagnetic interference gasket.

Example 14 incorporates the subject matter of any combination of Examples 11-13. In this example, the conductive element is one of a plurality of conductive elements to conductively couple the shield to the exposed ground.

Example 15 incorporates the subject matter of any combination of Examples 11-14. In this example, the method further includes compressing the conductive element by way of the conductively coupling of the shield to the exposed ground pad.

Example 16 incorporates the subject matter of any combination of Examples 11-15. In this example, the conductive element comprises a conductive adhesive to conductively couple the shield to the exposed ground pad.

Example 17 incorporates the subject matter of any combination of Examples 11-16. In this example, the method further includes generating a reduction in radio frequency interference associated with the signaling link via the coupling of the shield to the exposed ground pad.

Example 18 incorporates the subject matter of any combination of Examples 11-17. In this example, the method further includes generating an increase in impedance matching between the signaling link and a computing system associated with the signaling link via the coupling of the shield to the exposed ground pad.

Example 19 incorporates the subject matter of any combination of Examples 11-18. In this example, the method further includes forming the exposed ground pad adjacent to a connector operable to receive the signaling link.

Example 20 incorporates the subject matter of any combination of Examples 11-19. In this example, the signaling link does not include grounding pins.

Example 21 describes a system for signal grounding. The system includes a signaling link having a shield, an exposed ground pad of a circuit board, and a conductive means, wherein the conductive means is to conductively couple the shield of the signaling link to the exposed ground pad.

Example 22 incorporates the subject matter of Example 21. In this example, the signaling link is a flexible flat cable (FFC).

Example 23 incorporates the subject matter of any combination of Examples 21-22. In this example, the conductive means comprises a compressible electromagnetic interference gasket.

Example 24 incorporates the subject matter of any combination of Examples 21-23. In this example, the communicative coupling between the shield and conductive means is increased by the compressibility of the conductive means.

Example 25 incorporates the subject matter of any combination of Examples 21-24. In this example, the conductive means is one of a plurality of conductive elements to conductively couple the shield to the exposed ground.

Example 26 incorporates the subject matter of any combination of Examples 21-25. In this example, the conductive means comprises a conductive adhesive to communicatively couple the shield to the exposed ground pad.

Example 27 incorporates the subject matter of any combination of Examples 21-26. In this example, the communicative coupling between the shield and the exposed ground pad generates a reduction in radio frequency interference associated with the signaling link.

Example 28 incorporates the subject matter of any combination of Examples 21-27. In this example, the communicative coupling between the shield and the exposed ground pad generates an increase in impedance matching between the signaling link and a computing system associated with the signaling link.

Example 29 incorporates the subject matter of any combination of Examples 21-28. In this example, the exposed ground pad is adjacent to a connector operable to receive the signaling link.

Example 30 incorporates the subject matter of any combination of Examples 21-29. In this example, the signaling link does not include grounding pins.

Example 31 describes a means operable to carry out the method of any combination of Examples 11-20. In some cases, the means may include a computer-readable medium, such as a non-transitory computer readable medium, comprising code that when executed by a processing device may carry out the method. However, other means are considered, such as manufacturing devices for conductively coupling a conductive element to both a ground pad and a shield of a signaling link.

Example 32 describes an apparatus for signal grounding. The apparatus includes a means for conductively coupling to an exposed ground pad of a circuit board. The means for conductively coupling to an exposed ground pad is to conductively couple a shield of a signaling link to the exposed ground pad.

Example 33 incorporates the subject matter of Example 32. In this example, the signaling link is a flexible flat cable (FFC).

Example 34 incorporates the subject matter of any combination of Examples 32-33. In this example, the means for conductively coupling to an exposed ground pad comprises a compressible electromagnetic interference gasket.

Example 35 incorporates the subject matter of any combination of Examples 32-34. In this example, the conductively coupling between the shield and the means for conductively coupling to an exposed ground pad is increased by the compressibility of the means for conductively coupling to an exposed ground pad.

Example 36 incorporates the subject matter of any combination of Examples 32-35. In this example, the means for conductively coupling to an exposed ground pad is one of a plurality of means for conductively coupling to an exposed ground pad to conductively couple the shield to the exposed ground.

Example 37 incorporates the subject matter of any combination of Examples 32-36. In this example, the means for conductively coupling to an exposed ground pad comprises a conductive adhesive to conductively couple the shield to the exposed ground pad.

Example 38 incorporates the subject matter of any combination of Examples 32-37. In this example, the conductive coupling between the shield and the exposed ground pad generates a reduction in radio frequency interference associated with the signaling link.

Example 39 incorporates the subject matter of any combination of Examples 32-38. In this example, the communicative coupling between the shield and the exposed ground pad generates an increase in impedance matching between the signaling link and a computing system associated with the signaling link.

Example 40 incorporates the subject matter of any combination of Examples 32-39. In this example, the exposed ground pad is adjacent to a connector operable to receive the signaling link.

Example 41 incorporates the subject matter of any combination of Examples 32-40. In this example, the signaling link does not include grounding pins.

Example 42 describes a signaling link for signal grounding. The signaling link includes a means for conductively coupling to an exposed ground pad of a circuit board. The means for conductively coupling to an exposed ground pad is to conductively couple a shield of the signaling link to the exposed ground pad.

Example 43 incorporates the subject matter of Example 32. In this example, the signaling link is a flexible flat cable (FFC).

Example 44 incorporates the subject matter of any combination of Examples 42-43. In this example, the means for conductively coupling to an exposed ground pad comprises a compressible electromagnetic interference gasket.

Example 45 incorporates the subject matter of any combination of Examples 42-44. In this example, the conductively coupling between the shield and the means for conductively coupling to an exposed ground pad is increased by the compressibility of the means for conductively coupling to an exposed ground pad.

Example 46 incorporates the subject matter of any combination of Examples 42-45. In this example, the means for conductively coupling to an exposed ground pad is one of a plurality of means for conductively coupling to an exposed ground pad to conductively couple the shield to the exposed ground.

Example 47 incorporates the subject matter of any combination of Examples 42-46. In this example, the means for conductively coupling to an exposed ground pad comprises a conductive adhesive to conductively couple the shield to the exposed ground pad.

Example 48 incorporates the subject matter of any combination of Examples 42-47. In this example, the conductive coupling between the shield and the exposed ground pad generates a reduction in radio frequency interference associated with the signaling link.

Example 49 incorporates the subject matter of any combination of Examples 42-48. In this example, the communicative coupling between the shield and the exposed ground pad generates an increase in impedance matching between the signaling link and a computing system associated with the signaling link.

Example 50 incorporates the subject matter of any combination of Examples 42-49. In this example, the exposed ground pad is adjacent to a connector operable to receive the signaling link.

Example 51 incorporates the subject matter of any combination of Examples 42-40. In this example, the signaling link does not include grounding pins.

The various software components discussed herein may be stored on the tangible, non-transitory, computer-readable medium 1700, as indicated in FIG. 11. For example, a calibration application 1706 may be configured to successively change a coefficient setting at a remote transmitter based on a predetermined algorithm, and determine a margin value associated with each successive coefficient setting. The margin value that is the highest from among the margin values is determined.

In the description contained herein, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An apparatus for signal grounding, comprising:
a conductive element, wherein the conductive element is conductively coupled to an exposed ground pad of a circuit board; and
wherein the conductive element is to conductively couple a shield of a signaling link to the exposed ground pad.

2. The apparatus of claim 1, wherein the signaling link is a flexible flat cable (FFC).

3. The apparatus of claim 1, wherein the conductive element comprises a compressible electromagnetic interference gasket.

4. The apparatus of claim 3, wherein the conductively coupling between the shield and conductive element is increased by the compressibility of the conductive element.

5. The apparatus of claim 1, wherein the conductive element is one of a plurality of conductive elements to conductively couple the shield to the exposed ground.

6. The apparatus of claim 1, wherein the conductive element comprises a conductive adhesive to conductively couple the shield to the exposed ground pad.

7. The apparatus of claim 1, wherein the conductive coupling between the shield and the exposed ground pad generates a reduction in radio frequency interference associated with the signaling link.

8. The apparatus of claim 1, wherein the communicative coupling between the shield and the exposed ground pad generates an increase in impedance matching between the signaling link and a computing system associated with the signaling link.

9. The apparatus of claim 1, wherein the exposed ground pad is adjacent to a connector operable to receive the signaling link.

10. The apparatus of claim 1, wherein the signaling link does not include grounding pins.

11. A method for signal grounding, comprising:
conductively coupling a conductive element to an exposed ground pad of a circuit board; and
conductively coupling a shield of a signaling link to the exposed ground pad via the conductive element.

12. The method of claim 11, wherein the signaling link is a flexible flat cable (FFC).

13. The method of claim 11, wherein the conductive element comprises a compressible electromagnetic interference gasket.

14. The method of claim 11, wherein the conductive element is one of a plurality of conductive elements to conductively couple the shield to the exposed ground.

15. The method of claim 11, further comprising compressing the conductive element by way of the conductively coupling of the shield to the exposed ground pad.

16. The method of claim 11, wherein the conductive element comprises a conductive adhesive to conductively couple the shield to the exposed ground pad.

17. The method of claim 11, comprising generating a reduction in radio frequency interference associated with the signaling link via the coupling of the shield to the exposed ground pad.

18. The method of claim 11, comprising generating an increase in impedance matching between the signaling link and a computing system associated with the signaling link via the coupling of the shield to the exposed ground pad.

19. The method of claim 11, comprising forming the exposed ground pad adjacent to a connector operable to receive the signaling link.

20. The method of claim 11, wherein the signaling link does not include grounding pins.

21. A system for signal grounding, comprising:
a signaling link having a shield;
an exposed ground pad of a circuit board;
a conductive element, wherein the conductive element is to conductively couple the shield of the signaling link to the exposed ground pad.

22. The system of claim 21, wherein the signaling link is a flexible flat cable (FFC).

23. The system of claim 21, wherein the conductive element comprises a compressible electromagnetic interference gasket, and wherein the communicative coupling between the shield and conductive element is increased by the compressibility of the conductive element.

24. The system of claim 21, wherein the conductive element comprises a conductive adhesive to communicatively couple the shield to the exposed ground pad.

25. The system of claim 21, wherein the communicative coupling between the shield and the exposed ground pad generates a reduction in radio frequency interference associated with the signaling link.
